(19) United States
(12) Patent Application Publication
(10) Pub. No.: US 2013/0157920 A1
(43) Pub. Date: Jun. 20, 2013

(54) CLEANING, PURIFYING, TREATING, AND EXTRACTING COMPOSITIONS AND ASSOCIATED METHODS FOR UTILIZING THE SAME

(71) Applicant: MWJ, LLC, Eaton Rapids, MI (US)

(72) Inventors: Michael J. Sanchez, Apple Valley, MN (US); William D. Sanchez, Eaton Rapids, MI (US)

(73) Assignee: MWJ, LLC, Eaton Rapids, MI (US)

(21) Appl. No.: 13/764,036

(22) Filed: Feb. 11, 2013

Related U.S. Application Data
(63) Continuation-in-part of application No. 13/136,097, filed on Jul. 21, 2011.

(51) Int. Cl. C11D 3/04; C02F 1/68; E21B 43/24; C10G 21/12; E21B 43/16

(52) U.S. Cl. CPC C11D 3/044; C10G 21/12; E21B 43/16; E21B 43/2406; C02F 1/682
USPC 510/365; 208/288; 166/305.1; 166/303; 210/634; 210/749; 210/696; 210/660

(57) ABSTRACT

A process for purifying extracted oil, byproducts, and wastewater, including the steps of: providing a composition having at least one solvent, an alkaline agent, a deflocculant, at least one surfactant selected from the group comprising an alkoxylated alcohol surfactant, an alkylamino-polyethoxy-sulfate surfactant, a polyether-phosphate ester surfactant, a surfactant that is a phosphate ester of an ethoxylated alcohol, and a surfactant that is a polyethyleneglycol monoaklyl ether, and a bonding agent; and associating the composition with at least one of extracted oil, byproducts, and wastewater—including, but not limited to, froth, middlings, tailings, mature fine tailings, solids, and combinations thereof.

### CROSS-REFERENCES TO RELATED APPLICATIONS

This application is a continuation-in-part of U.S. application Ser. No. 13/136,097, filed Jul. 21, 2011, entitled “CLEANING AND PURIFYING COMPOSITIONS AND ASSOCIATED METHOD FOR PURIFYING PROCESS WATER FROM THE REFINEMENT OF PETROLEUM,” which is continuation of U.S. application Ser. No. 11/895,732, filed Aug. 27, 2007, entitled “CLEANING AND PURIFYING COMPOSITIONS AND ASSOCIATED METHOD FOR PURIFYING PROCESS WATER FROM THE REFINEMENT OF PETROLEUM,” now U.S. Pat. No. 7,985,721, all of which are hereby incorporated herein by reference in their entirety—including all references cited therein.

### BACKGROUND OF THE INVENTION

1. Field of the Invention

The present invention relates in general to cleaning, purifying, treating, and extracting compositions and, more particularly, to cleaning, purifying, treating, and extracting compositions for consumer, health science, and petroleum applications—just to name a few. Non-limiting examples of consumer applications include, for example, residential and household products, commercial surface cleaning products, dry cleaning products, and food service cleaning products. Non-limiting examples of health science applications include, for example, medical facility cleaning products, hand sanitizers, autoclave replacement products, products for medicinal topical use, and products for medicinal internal use. Non-limiting examples of petroleum applications include, for example, used oil recovery products, marginal well products, industrial cleaners, toxic site products, oil spill products, wild life cleanup products, tar sand products, shale oil products, steam-assisted gravity drainage (SAGD) oil extraction products, and products for the treatment of extracted oil, byproducts, and waste applications.

2. Background Art

Cleaning concentrates that remove grease from surfaces and disperse oil spills are well known. The prior art is replete with such concentrates. Much of the prior art is directed to general cleaning compositions. Of these, some prior art patents are directed to concentrates suitable for use as degreasing agents. For example, U.S. Pat. No. 4,704,225 teaches a composition for removing wax, grease, oils, and fats. This composition employs a terpene hydrocarbon, a fatty acid and water. Another example is provided in U.S. Pat. No. 5,527,486 which teaches a composition for removing tar and grease without any mechanical activity (i.e., scrubbing). This composition employs a polar solvent, a water soluble or dispersible amphiphile, and a non-polar solvent in combination. Yet another example is provided in U.S. Pat. No. 5,549,840 which teaches a composition for use in the removal of oily and greasy soil. This composition employs surfactants in combination with an ethoxylated glycerol. Additional, non-limiting examples are provided in U.S. Pat. No. 5,585,034, U.S. Pat. No. 5,527,486, U.S. Pat. No. 5,643,861, and U.S. Pat. No. 5,602,090.

While the prior art teachings can be useful, they are not without their shortcomings. For example, many formulations are toxic to the environment. As a result, the manner in which the concentrate can be used or disposed of after use is limited. A related shortcoming is that many compositions contain phosphates which can upset the ecosystems by causing planktonic blooms resulting in significant ecosystem imbalances.

Another shortcoming is that because oftentimes the formulation is discharged along with the greases, it may be used for only a single application, thus, increasing costs associated with cleanup.

Yet another disadvantage is that some prior art compositions are high foaming which creates pumping and disposal problems. Still another shortcoming of prior art compositions is that many are not biodegradable which means that the compositions may remain harmful to living beings long after being introduced into the environment.

Still another disadvantage of prior art compositions is that when used to “clean up” oil spills they often do not provide any means to facilitate oil collection. These compositions merely cause the oil to emulsify with the water rather than force separation which would facilitate cleanup. The emulsified oil is then spread by the action of wind, waves, and tides, which merely makes the water appear to be cleaner.

Another problem associated with conventional cleaning compositions is that they leave a residue which must be removed by, for example, immersing the object in an acid bath or by using organic solvents such as mineral spirits, naphtha, or xylene. All these materials and methods pose potential health hazards and result in additional costs in labor, materials, precautions, and proper disposal.

It is therefore an object of the present invention to provide a cleaning, purifying, treating, and extracting compositions for consumer, health science, and petroleum applications that reduce and/or eliminate the aforementioned drawbacks and complications associated with presently available cleaning, purifying, and treating compositions.

These and other objects of the present invention will become apparent in light of the present specification, claims, and drawings.

### SUMMARY OF THE INVENTION

The present invention is directed to a process for extracting crude oil, comprising the steps of: (a) providing an input source to an area of the earth having crude oil; (b) providing an output producer source to a recoverable area proximate the earth's surface; (c) introducing a composition through the input source to the area of the earth having the crude oil, wherein the composition comprises: at least one solvent, an alkaline agent, a deflocculant, at least one surfactant selected from the group comprising an alkoxylated alcohol surfactant, an alkylamino-polyethoxy-sulfate surfactant, a polyether-phosphate ester surfactant, a surfactant that is a phosphate ester of an ethoxylated alcohol, and a surfactant that is a polyethyleneglycol monoaklyl ether, and a bonding agent; and (d) extracting crude oil from the earth through the output producer source.

In a preferred embodiment of the present invention, the step of introducing a composition through the input source to the area of the earth having the crude oil includes the step of introducing the composition which comprises water, caustic soda, a deflocculant, an alkoxylated alcohol surfactant (e.g., Trycol 5941), an alkylamino-polyethoxy-sulfate surfactant, a polyether-phosphate ester surfactant, a surfactant that is a phosphate ester of an ethoxylated alcohol, a surfactant that is a polyethyleneglycol monoaklyl ether, and a bonding agent.

The present invention is also directed to a process for extracting crude oil using steam-assisted gravity drainage, comprising the steps of: (a) providing an input line to an area of the earth having crude oil; (b) providing an output producer line to a recoverable area proximate the earth's surface; (c) introducing steam through the input line; (d) introducing a composition through the input line to the area of the earth having the crude oil, wherein the composition comprises: at least one solvent, an alkaline agent, a deflocculant, at least one surfactant selected from the group comprising an alkoxylated alcohol surfactant, an alkylamino-polyethoxy-sulfate surfactant, a polyether-phosphate ester surfactant, a surfactant that is a phosphate ester of an ethoxylated alcohol, and a surfactant that is a polyethyleneglycol monoaklyl ether, and a bonding agent; and (e) extracting crude oil from the earth through the output producer line.

In another preferred embodiment of the present invention, the step of introducing a composition through the input source to the area of the earth having the crude oil includes the step of introducing the composition which comprises water, caustic soda, a deflocculant, an alkoxylated alcohol surfactant (e.g., Trycol 5941), an alkylamino-polyethoxy-sulfate surfactant, a polyether-phosphate ester surfactant, a surfactant that is a phosphate ester of an ethoxylated alcohol, a surfactant that is a polyethyleneglycol monoaklyl ether, and a bonding agent.

The present invention is further directed to a process for purifying extracted oil, byproducts, and wastewater, comprising the steps of: (a) providing a composition, wherein the composition comprises: at least one solvent, an alkaline agent, a deflocculant, at least one surfactant selected from the group comprising an alkoxylated alcohol surfactant, an alkylamino-polyethoxy-sulfate surfactant, a polyether-phosphate ester surfactant, a surfactant that is a phosphate ester of an ethoxylated alcohol, and a surfactant that is a polyethyleneglycol monoaklyl ether, and a bonding agent; and (b) associating the composition with at least one of extracted oil, byproducts, and wastewater.

In yet another preferred embodiment of the present invention, the step of providing the composition includes the step of providing the composition which comprises water, caustic soda, a deflocculant, an alkoxylated alcohol surfactant (e.g., Trycol 5941), an alkylamino-polyethoxy-sulfate surfactant, a polyether-phosphate ester surfactant, a surfactant that is a phosphate ester of an ethoxylated alcohol, a surfactant that is a polyethyleneglycol monoaklyl ether, and a bonding agent.

In another aspect of the present invention, the step of associating the composition with at least one of extracted oil, byproducts, and wastewater includes the step of associating the composition with one or more of froth, middlings, tailings, mature fine tailings, solids, and combinations thereof.

The present invention is also directed to a process for cleaning a surface, comprising the steps of: (a) providing a composition, wherein the composition comprises: at least one solvent, an alkaline agent, a deflocculant, at least one surfactant selected from the group comprising an alkoxylated alcohol surfactant, an alkylamino-polyethoxy-sulfate surfactant, a polyether-phosphate ester surfactant, a surfactant that is a phosphate ester of an ethoxylated alcohol, and a surfactant that is a polyethyleneglycol monoaklyl ether, and a bonding agent; and (b) associating the composition with the surface to be cleaned.

In a preferred embodiment of the present invention, the step of providing the composition which comprises water, caustic soda, a deflocculant, an alkoxylated alcohol surfactant (e.g., Trycol 5941), an alkylamino-polyethoxy-sulfate surfactant, a polyether-phosphate ester surfactant, a surfactant that is a phosphate ester of an ethoxylated alcohol, a surfactant that is a polyethyleneglycol monoaklyl ether, and a bonding agent.

In one embodiment, the present invention is directed to a cleaning and purifying composition comprising: (a) at least one solvent; (b) an alkaline agent; (c) a deflocculant; (d) one or more surfactants selected from the group comprising an alcohol ethoxylate surfactant; an alkylamino-polyethoxy-sulfate surfactant; a polyether-phosphate ester surfactant; a surfactant that is a phosphate ester of an ethoxylated alcohol; and a surfactant that is a polyethyleneglycol monoaklyl ether; and (e) a bonding agent.

In a preferred embodiment of the present invention, the at least one solvent comprises a polar solvent, such as water.

In another preferred embodiment of the present invention, the alkaline agent comprises at least one of a hydroxide salt and/or a carbonate salt.

In yet another preferred embodiment of the present invention, the alkaline agent comprises at least one of the group comprising LiOH, NaOH (i.e. caustic soda), KOH, RbOH, CsOH, FrOH, Be(OH)₂, Mg(OH)₂, Ca(OH)₂, Sr(OH)₂, Ba(OH)₂, Ra(OH)₂, and mixtures thereof.

In another aspect of the present invention, the deflocculant comprises at least one of a sodium silicate and an anhydrous sodium metasilicate.

In a preferred embodiment of the present invention, the bonding agent comprises an organic sulfonate, such as, for example, sodium xylene sulfonate.

Preferably, the percent by mass or percent by volume for each component identified in the compositions range from approximately 1 percent to approximately 33 percent.

The present invention is also directed to a cleaning and purifying composition, comprising: (a) water; (b) caustic soda; (c) a deflocculant; (d) an alcohol ethoxylate surfactant; (e) an alkylamino-polyethoxy-sulfate surfactant; (f) a polyether-phosphate ester surfactant; (g) a surfactant that is a phosphate ester of an ethoxylated alcohol; (h) a surfactant that is a polyethyleneglycol monoaklyl ether; and (i) a bonding agent.

The present invention is further directed to a cleaning and purifying composition, comprising: (a) water; (b) caustic soda; (c) sodium silicate; (d) an alcohol ethoxylate surfactant; (e) an alkylamino-polyethoxy-sulfate surfactant; (f) a polyether-phosphate ester surfactant; (g) a surfactant that is a phosphate ester of an ethoxylated alcohol; (h) a surfactant that is a polyethyleneglycol monoaklyl ether; and (i) sodium xylene sulfonate.

A process for purifying petroleum refinery process wastewater, is also disclosed as comprising the steps of: (a) providing a composition, comprising: water; caustic soda; a deflocculant; an alcohol ethoxylate surfactant; an alkylamino-polyethoxy-sulfate surfactant; a polyether-phosphate ester surfactant; a surfactant that is a phosphate ester of an ethoxylated alcohol; a surfactant that is a polyethyleneglycol monoaklyl ether; and a bonding agent; (b) transferring process water into a first fractioned pond and introducing the composition into the first fractioned pond, thereby partially treating the process water; (c) transferring the partially treated process water from the first fractioned pond into a second fractioned pond; (d) transferring the partially treated process water from the second fractioned pond into a third fractioned pond; (e) transferring the partially treated process water from the third fractioned pond to a hydrocyclone; (f) transferring the partially treated process water from the hydrocyclone to a precipitating tank thereby fully treating the same; and (g) recovering treated water from the precipitating tank.

### BRIEF DESCRIPTION OF THE DRAWINGS

The invention will now be described with reference to the drawings wherein:

FIG. 1 of the drawings is a schematic representation of a process for purifying petroleum refinery process wastewater in accordance with the present invention.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

In accordance with the present invention, novel cleaning, purifying, treating, and extracting compositions (i.e., a mixture or combination of chemicals) for consumer, health science, and petroleum applications are provided. The compositions provide unique characteristics and properties that include, but are not limited to, being non-toxic and safe for the environment, low foaming, biodegradable, non-carcinogenic, disinfectant, non-flammable, and unexpectedly effective. Representative examples of consumer applications include, for example, residential and household products, commercial surface cleaning products, dry cleaning products, and food service cleaning products. Non-limiting examples of health science applications include, for example, medical facility cleaning products, hand sanitizers, autoclave replacement products, products for medicinal topical use, and products for medicinal internal use. Preferred examples of petroleum applications include, for example, used oil recovery products, marginal well products, industrial cleaners, toxic site products, oil spill products, wild life cleanup products, tar sand products, shale oil products, steam-assisted gravity drainage (SAGD) oil extraction products, and products for the treatment of extracted oil, byproducts, and waste/waste water applications—including, but not limited to, cleaning, purifying, treating, and extracting one or more of froth, middlings, tailings, mature fine tailings, solids, and combinations thereof.

In accordance with the present invention, a process for extracting crude oil is disclosed which, comprises, consists and/or consists essentially of the steps of: (a) providing an input source (e.g., line) to an area of the earth having crude oil; (b) providing an output producer source (e.g., line) to a recoverable area proximate the earth's surface; (c) introducing a composition through the input source to the area of the earth having the crude oil, wherein the composition comprises: at least one solvent, an alkaline agent, a deflocculant, at least one surfactant selected from the group comprising an alkoxylated alcohol surfactant, an alkylamino-polyethoxy-sulfate surfactant, a polyether-phosphate ester surfactant, a surfactant that is a phosphate ester of an ethoxylated alcohol, and a surfactant that is a polyethyleneglycol monoaklyl ether, and a bonding agent; and (d) extracting crude oil from the earth through the output producer source. It will be understood that such a process may augment and/or replace conventional mining and/or steam assisted gravity drainage (SAGD).

The present invention further discloses a process for extracting crude oil using steam-assisted gravity drainage, comprising the steps of: (a) providing an input line to an area of the earth having crude oil; (b) providing an output producer line to a recoverable area proximate the earth's surface; (c) introducing steam through the input line; (d) introducing a composition through the input line to the area of the earth having the crude oil, wherein the composition comprises: at least one solvent, an alkaline agent, a deflocculant, at least one surfactant selected from the group comprising an alkoxylated alcohol surfactant, an alkylamino-polyethoxy-sulfate surfactant, a polyether-phosphate ester surfactant, a surfactant that is a phosphate ester of an ethoxylated alcohol, and a surfactant that is a polyethyleneglycol monoaklyl ether, and a bonding agent; and (e) extracting crude oil from the earth through the output producer line. It will be understood that such a process facilitates oil extraction at lower temperatures and pressures, as well as minimizes any problems associated with cap blowing and resulting sink holes. Moreover, the present process is operable utilizing steam, warm water, and/or ambient temperature water.

The present invention is also directed to a process for purifying extracted oil, byproducts, and wastewater, comprising the steps of: (a) providing a composition, wherein the composition comprises: at least one solvent, an alkaline agent, a deflocculant, at least one surfactant selected from the group comprising an alkoxylated alcohol surfactant, an alkylamino-polyethoxy-sulfate surfactant, a polyether-phosphate ester surfactant, a surfactant that is a phosphate ester of an ethoxylated alcohol, and a surfactant that is a polyethyleneglycol monoaklyl ether, and a bonding agent; and (b) associating (e.g., contacting, spraying, mixing, admixing, dripping, etcetera) the composition with at least one of extracted oil, byproducts, and wastewater (e.g., oil, froth, middlings, tailings, mature fine tailings, solids, water, waste water, and combinations thereof).

In this embodiment, the step of providing the composition includes the step of providing the composition which comprises water, caustic soda, a deflocculant, an alkoxylated alcohol surfactant, an alkylamino-polyethoxy-sulfate surfactant, a polyether-phosphate ester surfactant, a surfactant that is a phosphate ester of an ethoxylated alcohol, a surfactant that is a polyethyleneglycol monoaklyl ether, and a bonding agent.

It will be understood that the alkoxylated alcohol surfactant disclosed herein may comprise Trycol 5941. Non-limiting examples of other alkoxylated alcohol surfactants include: Arachideth-20, Beheneth-5, Beheneth-10, Beheneth-15, Beheneth-20, Beheneth-25, Beheneth-30, Bis(PPG-7 Undeceneth-21) Dimethicone, Buteth-3, Capryleth-4, Capryleth-5, Ceteareth-2, Ceteareth-3, Ceteareth-4, Ceteareth-5, Ceteareth-6, Ceteareth-7, Ceteareth-8, Ceteareth-9, Ceteareth-10, Ceteareth-11, Ceteareth-12, Ceteareth-13, Ceteareth-14, Ceteareth-15, Ceteareth-16, Ceteareth-17, Ceteareth-18, Ceteareth-20, Ceteareth-22, Ceteareth-23, Ceteareth-24, Ceteareth-25, Ceteareth-27, Ceteareth-28, Ceteareth-29, Ceteareth-30, Ceteareth-33, Ceteareth-34, Ceteareth-40, Ceteareth-50, Ceteareth-55, Ceteareth-60, Ceteareth-80, Ceteareth-100, Ceteareth-60 Myristyl Glycol, Ceteareth-7 Stearate, Ceteth-1, Ceteth-2, Ceteth-3, Ceteth-4, Ceteth-5, Ceteth-6, Ceteth-7, Ceteth-10, Ceteth-12, Ceteth-13, Ceteth-14, Ceteth-15, Ceteth-16, Ceteth-17, Ceteth-18, Ceteth-20, Ceteth-23, Ceteth-24, Ceteth-25, Ceteth-30, Ceteth-40, Ceteth-45, Ceteth-150, Cetoleth-2, Cetoleth-4, Cetoleth-5, Cetoleth-6, Cetoleth-10, Cetoleth-11, Cetoleth-15, Cetoleth-18, Cetoleth-20, Cetoleth-22, Cetoleth-24, Cetoleth-25, Cetoleth-30, Cetyl C12-15 Pareth-8 Carboxylate, Choleth-5, Choleth-10, Choleth-15, Choleth-20, Choleth-24, Choleth-30, Coceth-3, Coceth-5, Coceth-6, Coceth-7, Coceth-8, Coceth-10, Coceth-20, Coceth-25, C9-11 Pareth-3, C9-11 Pareth-6, C9-11 Pareth-8, C9-15 Pareth-8, C11-13 Pareth-6, C11-13 Pareth-9, C11-13 Pareth-10, C11-15 Pareth-3, C11-15 Pareth-5, C11-15 Pareth-7, C11-15 Pareth-9, C11-15 Pareth-12, C11-15 Pareth-15, C11-15 Pareth-20, C11-15 Pareth-30, C11-15 Pareth-40, C11-21-Pareth-3, C11-21-Pareth-10, C12-13 Pareth-2, C12-13 Pareth-3, C12-13 Pareth-4, C12-13 Pareth-5, C12-13 Pareth-6, C12-13 Pareth-7, C12-13 Pareth-9, C12-13 Pareth-10, C12-13 Pareth-15, C12-13 Pareth-23, C12-14 Pareth-3, C12-14 Pareth-5, C12-14 Pareth-7, C12-14 Pareth-9, C12-14 Pareth-12, C12-15 Pareth-2, C12-15 Pareth-3, C12-15 Pareth-4, C12-15 Pareth-5, C12-15 Pareth-7, C12-15 Pareth-9, C12-15 Pareth-10, C12-15 Pareth-11, C12-15 Pareth-12, C12-16 Pareth-5, C12-16 Pareth-7, C12-16 Pareth-9, C13-15 Pareth-21, C14-15 Pareth-4, C14-15 Pareth-7, C14-15 Pareth-8, C14-15 Pareth-11, C14-15 Pareth-12, C14-15 Pareth-13, C20-22 Pareth-30, C20-40 Pareth-3, C20-40 Pareth-10, C20-40 Pareth-24, C20-40 Pareth-40, C20-40 Pareth-95, C22-24 Pareth-33, C30-50 Pareth-3, C30-50 Pareth-10, C30-50 Pareth-40, C40-60 Pareth-3, C40-60 Pareth-10, C12-15 Pareth-3 Benzoate, C12-15 Pareth-6 Phosphate, C11-15 Sec-Pareth-12, C12-14 Sec-Pareth-3, C12-14 Sec-Pareth-5, C12-14 Sec-Pareth-7, C12-14 Sec-Pareth-8, C12-14 Sec-Pareth-9, C12-14 Sec-Pareth-12, C12-14 Sec-Pareth-15, C12-14 Sec-Pareth-20, C12-14 Sec-Pareth-30, C12-14 Sec-Pareth-40, C12-14 Sec-Pareth-50, Deceth-3, Deceth-4, Deceth-5, Deceth-6, Deceth-7, Deceth-8, Deceth-9, Deceth-10, Decyltetradeceth-30, Diglycereth-7 Malate, Dihydrocholeth-15, Dihydrocholeth-20, Dihydrocholeth-30, Di-PPG-3 Ceteth-4 Adipate, Di-PPG-2 Myreth-10 Adipate, Di-PPG-3 Myristyl Ether Adipate, Dodoxynol-5, Dodoxynol-6, Dodoxynol-7, Dodoxynol-9, Dodoxynol-12, Dodoxynol-13, Glycereth-7, Glycereth-12, Glycereth-20, Glycereth-26, Glycereth-31, Glycereth-7 Benzoate, Glycereth-18 Benzoate, Glycereth-20 Benzoate, Glycereth-2 Cocoate, Glycereth-5 Cocoate, Glycereth-17 Cocoate, Glycereth-7 Diisononanoate, Glycereth-7 Glycolate, Glycereth-8 Hydroxystearate, Glycereth-5 Lactate, Glycereth-7 Lactate, Glycereth-25 PCA Isostearate, Glycereth-20 Stearate, Glycereth-7 Triacetate, Glycereth-7 Trimethyl Ether, Glycofurol, Hexyldeceth-2, Hexyldeceth-20, Hydrogenated Laneth-5, Hydrogenated Laneth-20, Hydrogenated Laneth-25, Hydrogenated Talloweth-12, Hydrogenated Talloweth-25, Hydrogenated Talloweth-60 Myristyl Glycol, Hydroxyceteth-60, Isoceteth-5, Isoceteth-7, Isoceteth-10, Isoceteth-12, Isoceteth-15, Isoceteth-20, Isoceteth-25, Isoceteth-30, Isodeceth-4, Isodeceth-5, Isodeceth-6, Isolaureth-3, Isolaureth-6, Isolaureth-10, Isolaureth-4 Phosphate, Isomyreth-3, Isomyreth-9, Isopropylidenediphenol Bishydroxypropyl PEG-180, Isosteareth-2, Isosteareth-3, Isosteareth-5, Isosteareth-10, Isosteareth-12, Isosteareth-15, Isosteareth-20, Isosteareth-22, Isosteareth-25, Isosteareth-50, Laneth-5, Laneth-10, Laneth-15, Laneth-16, Laneth-20, Laneth-25, Laneth-40, Laneth-50, Laneth-60, Laneth-75, Laureth-1, Laureth-2, Laureth-3, Laureth-4, Laureth-5, Laureth-6, Laureth-7, Laureth-8, Laureth-9, Laureth-10, Laureth-11, Laureth-12, Laureth-13, Laureth-14, Laureth-15, Laureth-16, Laureth-20, Laureth-21, Laureth-23, Laureth-25, Laureth-30, Laureth-38, Laureth-40, Laureth-50, Laureth-5 Butyl Ether, Laureth-13 PG-Hydroxyethylcellulose, Laureth-1 Phosphate, Methoxy PEG-7, Methoxy PEG-10, Methoxy PEG-16, Methoxy PEG-25, Methoxy PEG-40, Methoxy PEG-100, Methoxy PEG-17/Dodecyl Glycol Copolymer, Methoxy PEG-22/Dodecyl Glycol Copolymer, Methyl Gluceth-10, Methyl Gluceth-20, Methyl Gluceth-20 Benzoate, Methylpolysiloxane Emulsion, Myreth-2, Myreth-3, Myreth-4, Myreth-5, Myreth-10, Noneth-8, Nonoxynol-1, Nonoxynol-2, Nonoxynol-3, Nonoxynol-4, Nonoxynol-5, Nonoxynol-6, Nonoxynol-7, Nonoxynol-8, Nonoxynol-9, Nonoxynol-10, Nonoxynol-11, Nonoxynol-12, Nonoxynol-13, Nonoxynol-14, Nonoxynol-15, Nonoxynol-18, Nonoxynol-20, Nonoxynol-23, Nonoxynol-25, Nonoxynol-30, Nonoxynol-35, Nonoxynol-40, Nonoxynol-44, Nonoxynol-50, Nonoxynol-70, Nonoxynol-100, Nonoxynol-120, Nonoxynol-9 Iodine, Nonoxynol-12 Iodine, Nonoxynol-4 Phosphate, Nonyl Nonoxynol-5, Nonyl Nonoxynol-10, Nonyl Nonoxynol-30, Nonyl Nonoxynol-49, Nonyl Nonoxynol-100, Nonyl Nonoxynol-150, Octoxynol-1, Octoxynol-3, Octoxynol-5, Octoxynol-6, Octoxynol-7, Octoxynol-8, Octoxynol-9, Octoxynol-10, Octoxynol-11, Octoxynol-12, Octoxynol-13, Octoxynol-16, Octoxynol-20, Octoxynol-25, Octoxynol-30, Octoxynol-33, Octoxynol-40, Octoxynol-70, Octyldodeceth-2, Octyldodeceth-5, Octyldodeceth-10, Octyldodeceth-16, Octyldodeceth-20, Octyldodeceth-25, Octyldodeceth-30, Oleth-2, Oleth-3, Oleth-4, Oleth-5, Oleth-6, Oleth-7, Oleth-8, Oleth-9, Oleth-10, Oleth-11, Oleth-12, Oleth-15, Oleth-16, Oleth-20, Oleth-23, Oleth-24, Oleth-25, Oleth-30, Oleth-35, Oleth-40, Oleth-44, Oleth-50, Oleth-82, Oleth-106, Oleth-2 Benzoate, Palmeth-2, Palmeth-2 Phosphate, PEG-4, PEG-6, PEG-7, PEG-8, PEG-9, PEG-10, PEG-12, PEG-14, PEG-16, PEG-18, PEG-20, PEG-32, PEG-33, PEG-40, PEG-45, PEG-55, PEG-60, PEG-75, PEG-80, PEG-90, PEG-100, PEG-135, PEG-150, PEG-180, PEG-200, PEG-220, PEG-240, PEG-350, PEG-400, PEG-450, PEG-500, PEG-800, PEG-6 Almond Glycerides, PEG-20 Almond Glycerides, PEG-60 Almond Glycerides, PEG-192 Apricot Kernel Glycerides, PEG-8 Avocadoate, PEG-11 Avocado Glycerides, PEG-14 Avocado Glycerides, PEG-11 Babassu Glycerides, PEG-42 Babassu Glycerides, PEG-6 Beeswax, PEG-8 Beeswax, PEG-12 Beeswax, PEG-20 Beeswax, PEG-2 Benzyl Ether, PEG-15 Butanediol, PEG-3 Butylene Glycol Laurate, PEG-6 Butylene Glycol Laurate, PEG-9 Butylene Glycol Laurate, PEG-12 Carnauba, PEG-2 Castor Oil, PEG-3 Castor Oil, PEG-4 Castor Oil, PEG-5 Castor Oil, PEG-8 Castor Oil, PEG-9Castor Oil, PEG-10 Castor Oil, PEG-11 Castor Oil, PEG-15 Castor Oil, PEG-16 Castor Oil, PEG-20 Castor Oil, PEG-25 Castor Oil, PEG-26 Castor Oil, PEG-29 Castor Oil, PEG-30 Castor Oil, PEG-33 Castor Oil, PEG-35 Castor Oil, PEG-36 Castor Oil, PEG-40 Castor Oil, PEG-44 Castor Oil, PEG-50 Castor Oil, PEG-54 Castor Oil, PEG-55 Castor Oil, PEG-60 Castor Oil, PEG-75 Castor Oil, PEG-80 Castor Oil, PEG-100 Castor Oil, PEG-200 Castor Oil, PEG-18 Castor Oil Dioleate, PEG-60 Castor Oil Isostearate, PEG-16 Cetyi/Oieyi/Stearyi/Lanilin Alcohol Ether, PEG-Cetyl Stearyl Diether, PEG-11 Cocoa Butter Glycerides, PEG-75 Cocoa Butter Glycerides, PEG-9 Cocoglycerides, PEG-20 Corn Glycerides, PEG-60 Corn Glycerides, PEG-5 DEDM Hydantoin, PEG-15 DEDM Hydantoin, PEG-5 DEDM Hydantoin Oleate, PEG-15 DEDM Hydantoin Stearate, PEG-13 Diphenylol Propane, PEG-22/Dodecyl Glycol Copolymer, PEG-45/Dodecyl Glycol Copolymer, PEG-20 Evening Primrose Glycerides, PEG-60 Evening Primrose Glycerides, PEG-6 Glyceryl Caprate, PEG-3 Glyceryl Cocoate, PEG-7 Glyceryl Cocoate, PEG-30 Glyceryl Cocoate, PEG-40 Glyceryl Cocoate, PEG-78 Glyceryl Cocoate, PEG-80 Glyceryl Cocoate, PEG-12 Glyceryl Dimyristate, PEG-12 Glyceryl Dioleate, PEG-4 Glyceryl Distearate, PEG-12 Glyceryl Distearate, PEG-23 Glyceryl Distearate, PEG-3 Glyceryl Isostearate, PEG-5 Glyceryl Isostearate, PEG-6 Glyceryl Isostearate, PEG-8 Glyceryl Isostearate, PEG-9 Glyceryl Isostearate, PEG-10 Glyceryl Isostearate, PEG-15 Glyceryl Isostearate, PEG-20 Glyceryl Isostearate, PEG-25 Glyceryl Isostearate, PEG-30 Glyceryl Isostearate, PEG-40 Glyceryl Isostearate, PEG-50 Glyceryl Isostearate, PEG-60 Glyceryl Isostearate, PEG-90 Glyceryl Isostearate, PEG-7 Glyceryl Laurate, PEG-8 Glyceryl Laurate, PEG-12 Glyceryl Laurate, PEG-15 Glyceryl Laurate, PEG-20 Glyceryl Laurate, PEG-23 Glyceryl Laurate, PEG-30 Glyceryl Laurate, PEG-5 Glyceryl Oleate, PEG-10 Glyceryl Oleate, PEG-15 Glyceryl Oleate, PEG-20 Glyceryl Oleate, PEG-25 Glyceryl Oleate, PEG-30 Glyceryl Oleate, PEG-18 Glyceryl Oleate/Cocoate, PEG-15 Glyceryl Ricinoleate, PEG-20 Glyceryl Ricinoleate, PEG-5 Glyceryl Sesquioleate, PEG-7 Glyceryl Soyate, PEG-5 Glyceryl Stearate, PEG-10 Glyceryl Stearate, PEG-15 Glyceryl Stearate, PEG-20 Glyceryl Stearate, PEG-25 Glyceryl Stearate, PEG-30 Glyceryl Stearate, PEG-40 Glyceryl Stearate, PEG-60 Glyceryl Stearate, PEG-120 Glyceryl Stearate, PEG-200 Glyceryl Stearate, PEG-28 Glyceryl Tallowate, PEG-80 Glyceryl Tallowate, PEG-82 Glyceryl Tallowate, PEG-130 Glyceryl Tallowate, PEG-200 Glyceryl Tallowate, PEG-2 Hydrogenated Castor Oil, PEG-5 Hydrogenated Castor Oil, PEG-6 Hydrogenated Castor Oil, PEG-7 Hydrogenated Castor Oil, PEG-8 Hydrogenated Castor Oil, PEG-10 Hydrogenated Castor Oil, PEG-16 Hydrogenated Castor Oil, PEG-20 Hydrogenated Castor Oil, PEG-25 Hydrogenated Castor Oil, PEG-30 Hydrogenated Castor Oil, PEG-35 Hydrogenated Castor Oil, PEG-40 Hydrogenated Castor Oil, PEG-45 Hydrogenated Castor Oil, PEG-50 Hydrogenated Castor Oil, PEG-54 Hydrogenated Castor Oil, PEG-55 Hydrogenated Castor Oil, PEG-60 Hydrogenated Castor Oil, PEG-65 Hydrogenated Castor Oil, PEG-80 Hydrogenated Castor Oil, PEG-100 Hydrogenated Castor Oil, PEG-200 Hydrogenated Castor Oil, PEG-5 Hydrogenated Castor Oil Isostearate, PEG-10 Hydrogenated Castor Oil Isostearate, PEG-15 Hydrogenated Castor Oil Isostearate, PEG-20 Hydrogenated Castor Oil Isostearate, PEG-30 Hydrogenated Castor Oil Isostearate, PEG-40 Hydrogenated Castor Oil Isostearate, PEG-50 Hydrogenated Castor Oil Isostearate, PEG-58 Hydrogenated Castor Oil Isostearate, PEG-20 Hydrogenated Castor Oil PCA Isostearate, PEG-30 Hydrogenated Castor Oil PCA Isostearate, PEG-40 Hydrogenated Castor Oil PCA Isostearate, PEG-60 Hydrogenated Castor Oil PCA Isostearate, PEG-50 Hydrogenated Castor Oil Succinate, PEG-5 Hydrogenated Castor Oil Triisostearate, PEG-10 Hydrogenated Castor Oil Triisostearate, PEG-15 Hydrogenated Castor Oil Triisostearate, PEG-20 Hydrogenated Castor Oil Triisostearate, PEG-30 Hydrogenated Castor Oil Triisostearate, PEG-40 Hydrogenated Castor Oil Triisostearate, PEG-50 Hydrogenated Castor Oil Triisostearate, PEG-60 Hydrogenated Castor Oil Triisostearate, PEG-5 Hydrogenated Corn Glycerides, PEG-8 Hydrogenated Fish Glycerides, PEG-200 Hydrogenated Glyceryl Palmate, PEG-20 Hydrogenated Palm Glycerides, PEG-6 Hydrogenated Palm/Palm Kernel Glyceride, PEG-6 Isolauryl Thioether, PEG-8 Isolauryl Thioether, PEG-10 Isolauryl Thioether, PEG-15 Jojoba Alcohol, PEG-26 Jojoba Alcohol, PEG-40 Jojoba Alcohol, PEG-5 Lanolin, PEG-10 Lanolin, PEG-20 Lanolin, PEG-24 Lanolin, PEG-27 Lanolin, PEG-30 Lanolin, PEG-35 Lanolin, PEG-40 Lanolin, PEG-50 Lanolin, PEG-55 Lanolin, PEG-60 Lanolin, PEG-75 Lanolin, PEG-85 Lanolin, PEG-100 Lanolin, PEG-150 Lanolin, PEG-75 Lanolin Oil, PEG-75 Lanolin Wax, PEG-2M, PEG-5M, PEG-7M, PEG-9M, PEG-14M, PEG-20M, PEG-23M, PEG-25M, PEG-45M, PEG-65M, PEG-90M, PEG-115M, PEG-160M, PEG-180M, PEG-16 Macadamia Glycerides, PEG-70 Mango Glycerides, PEG-20 Mannitan Laurate, PEG-75 Meadowfoam Oil, PEG-1182 Methyl Ester Sericin, PEG-3 Methyl Ether, PEG-4 Methyl Ether, PEG-6 Methyl Ether, PEG-7 Methyl Ether, PEG-120 Methyl Glucose Dioleate, PEG-20 Methyl Glucose Sesquistearate, PEG-120 Methyl Glucose Trioleate, PEG-13 Mink Glycerides, PEG-25 Moringa Glycerides, PEG-42 Mushroom Glycerides, PEG-7 Beta-Naphthol, PEG-2 Olive Glycerides, PEG-6 Olive Glycerides, PEG-7 Olive Glycerides, PEG-10 Olive Glycerides, PEG-40 Olive Glycerides, PEG-18 Palm Glycerides, PEG-12 Palm Kernel Glycerides, PEG-45 Palm Kernel Glycerides, PEG-60 Passiflora Edulis Seed Glycerides, PEG-60 Passiflora Incarnata Seed Glycerides, PEG-5 Pentaerythrityl Ether, PEG-15 Pentaerythrityl Tetra(Laureth-6 Carboxylate), PEG-5 Phytosterol, PEG-10 Phytosterol, PEG-15 Phytosterol, PEG-20 Phytosterol, PEG-25 Phytosterol, PEG-30 Phytosterol, PEG-4 Polyglyceryl-2 Distearate, PEG-10 Polyglyceryl-2 Laurate, PEG-4 Polyglyceryl-2 Stearate, PEG/PPG-20/22 Butyl Ether Dimethicone, PEG/PPG-23/23 Butyl Ether Dimethicone, PEG-4-PPG-7 C13/C15 Alcohol, PEG/PPG-8/3 Diisostearate, PEG/PPG-3/6 Dimethyl Ether, PEG/PPG-7/12 Dimethyl Ether, PEG/PPG-9/2 Dimethyl Ether, PEG/PPG-14/7 Dimethyl Ether, PEG/PPG-17/4 Dimethyl Ether, PEG/PPG-22/40 Dimethyl Ether, PEG/PPG-27/14 Dimethyl Ether, PEG/PPG-35/40 Dimethyl Ether, PEG/PPG-36/41 Dimethyl Ether, PEG/PPG-50/40 Dimethyl Ether, PEG/PPG-55/28 Dimethyl Ether, PEG-20-PPG-10 Glyceryl Stearate, PEG/PPG-2/5 Tocopheryl Ether, PEG/PPG-5/10 Tocopheryl Ether, PEG/PPG-5/20 Tocopheryl Ether, PEG/PPG-5/30 Tocopheryl Ether, PEG/PPG-30/10 Tocopheryl Ether, PEG/PPG-50/20 Tocopheryl Ether, PEG/PPG-70/30 Tocopheryl Ether, PEG/PPG-100/70 Tocopheryl Ether, PEG-10 Propylene Glycol, PEG-6 Propylene Glycol Caprylate/Caprate, PEG-8 Propylene Glycol Cocoate, PEG-55 Propylene Glycol Oleate, PEG-25 Propylene Glycol Stearate, PEG-75 Propylene Glycol Stearate, PEG-120 Propylene Glycol Stearate, PEG-5 Rapeseed Sterol, PEG-10 Rapeseed Sterol, PEG-45 Safflower Glycerides, PEG-50 Shea Butter, PEG-60 Shea Butter Glycerides, PEG-75 Shea Butter Glycerides, PEG-75 Shorea Butter Glycerides, PEG-75 Beta-Sitosterol, PEG-35 Soy Glycerides, PEG-75 Soy Glycerides, PEG-5 Soy Sterol, PEG-10 Soy Sterol, PEG-16 Soy Sterol, PEG-20 Soy Sterol, PEG-25 Soy Sterol, PEG-30 Soy Sterol, PEG-40 Soy Sterol, PEG-2 Sunflower Glycerides, PEG-7 Sunflower Glycerides, PEG-10 Sunflower Glycerides, PEG-13 Sunflower Glycerides, PEG-5 Tall Oil Sterol, PEG-66 Trihydroxystearin, PEG-200 Trihydroxystearin, PEG-5 Trilauryl Citrate, PEG-5 Trimyristyl Citrate, PEG-5 Tristearyl Citrate, Pentadoxynol-200, Polyoxypropylene Glyceryl Ether Phosphate, Potassium Laureth Phosphate, Potassium PEG-50 Hydrogenated Castor Oil Succinate, Potassium Trideceth-6 Phosphate, Potassium Trideceth-7 Phosphate, PPG-3, PPG-7, PPG-9, PPG-12, PPG-13, PPG-15, PPG-16, PPG-17, PPG-20, PPG-26, PPG-30, PPG-33, PPG-34, PPG-51, PPG-69, PPG-1 Beheneth-15, PPG-3 Benzyl Ether Myristate, PPG-10 Butanediol, PPG-2-Buteth-1, PPG-2-Buteth-2, PPG-2-Buteth-3, PPG-3-Buteth-5, PPG-4-Buteth-4, PPG-5-Buteth-5, PPG-5-Buteth-7, PPG-7-Buteth-4, PPG-7-Buteth-10, PPG-9-Buteth-12, PPG-10-Buteth-9, PPG-12-Buteth-12, PPG-12-Buteth-16, PPG-15-Buteth-20, PPG-17-Buteth-17, PPG-19-Buteth-19, PPG-20-Buteth-30, PPG-24-Buteth-27, PPG-26-Buteth-26, PPG-28-Buteth-35, PPG-30-Buteth-30, PPG-33-Buteth-45, PPG-36-Buteth-36, PPG-38-Buteth-37, PPG-2 Butyl Ether, PPG-3 Butyl Ether, PPG-4 Butyl Ether, PPG-5 Butyl Ether, PPG-9 Butyl Ether, PPG-12 Butyl Ether, PPG-14 Butyl Ether, PPG-15 Butyl Ether, PPG-16 Butyl Ether, PPG-17 Butyl Ether, PPG-18 Butyl Ether, PPG-20 Butyl Ether, PPG-22 Butyl Ether, PPG-24 Butyl Ether, PPG-26 Butyl Ether, PPG-30 Butyl Ether, PPG-33 Butyl Ether, PPG-40 Butyl Ether, PPG-52 Butyl Ether, PPG-53 Butyl Ether, PPG-21 Butyl Ether Phosphate, PPG-25 Butyl Ether Phosphate, PPG-35 Butyl Ether Phosphate, PPG-12 Capryleth-18, PPG-30-Capryleth-4 Phosphate, PPG-2-Ceteareth-9, PPG-4-Ceteareth-12, PPG-10-Ceteareth-20, PPG-1-Ceteth-1, PPG-1-Ceteth-5, PPG-1-Ceteth-10, PPG-1-Ceteth-20, PPG-2-Ceteth-1, PPG-2-Ceteth-5, PPG-2-Ceteth-10, PPG-2-Ceteth-20, PPG-4-Ceteth-1, PPG-4-Ceteth-5, PPG-4-Ceteth-10, PPG-4-Ceteth-20, PPG-5-Ceteth-20, PPG-8-Ceteth-1, PPG-8-Ceteth-2, PPG-8-Ceteth-5, PPG-8-Ceteth-10, PPG-8-Ceteth-20, PPG-10 Cetyl Ether, PPG-20 Cetyl Ether, PPG-28 Cetyl Ether, PPG-30 Cetyl Ether, PPG-50 Cetyl Ether, PPG-2 C12-13 Pareth-8, PPG-2 C12-15 Pareth-6, PPG-4 C13-15 Pareth-15, PPG-5 C9-15 Pareth-6, PPG-6 C9-11 Pareth-5, PPG-6 C12-15 Pareth-12, PPG-6 C12-18 Pareth-11, PPG-3 C12-14 Sec-Pareth-7, PPG-4 C12-14 Sec-Pareth-5, PPG-5 C12-14 Sec-Pareth-7, PPG-5 C12-14 Sec-Pareth-9, PPG-1-Deceth-6, PPG-2-Deceth-3, PPG-2-Deceth-7, PPG-2-Deceth-10, PPG-2-Deceth-12, PPG-2-Deceth-15, PPG-2-Deceth-20, PPG-2-Deceth-30, PPG-2-Deceth-40, PPG-2-Deceth-50, PPG-2-Deceth-60, PPG-4-Deceth-4, PPG-4-Deceth-6, PPG-6-Deceth-4, PPG-6-Deceth-9, PPG-8-Deceth-6, PPG-14-Deceth-6, PPG-6-Decyltetradeceth-12, PPG-6-Decyltetradeceth-20, PPG-6-Decyltetradeceth-30, PPG-13-Decyltetradeceth-24, PPG-20-Decyltetradeceth-10, PPG-4 Diglyceryl Ether, PPG-9 Diglyceryl Ether, PPG-14 Diglyceryl Ether, PPG-18 Diglyceryl Ether, PPG-20 Diglyceryl Ether, PPG-24 Diglyceryl Ether, PPG-9-Ethyl hexeth-5, PPG-20-Giycereth-30, PPG-24-Giycereth-24, PPG-25 Giycereth-22, PPG-66-Giycereth-12, PPG-10 Glyceryl Ether, PPG-27 Glyceryl Ether, PPG-55 Glyceryl Ether, PPG-3 Hydrogenated Castor Oil, PPG-2 lsoceteth-20 Acetate, PPG-30 Isocetyl Ether, PPG-2-Isodeceth-4, PPG-2-Isodeceth-6, PPG-2-Isodeceth-8, PPG-2-Isodeceth-9, PPG-2-Isodeceth-10, PPG-2-Isodeceth-12, PPG-2-Isodeceth-18, PPG-2-Isodeceth-25, PPG-3-Isodeceth-1, PPG-4-Isodeceth-10, PPG-3-Isosteareth-9, PPG-4 Jojoba Alcohol, PPG-10 Jojoba Alcohol, PPG-12-Laneth-50, PPG-2 Lanolin Alcohol Ether, PPG-5 Lanolin Alcohol Ether, PPG-10 Lanolin Alcohol Ether, PPG-20 Lanolin Alcohol Ether, PPG-30 Lanolin Alcohol Ether, PPG-5 Lanolin Wax, PPG-5 Lanolin Wax Glyceride, PPG-2-Laureth-5, PPG-2-Laureth-8, PPG-3-Laureth-8, PPG-3-Laureth-9, PPG-3-Laureth-10, PPG-3-Laureth-12, PPG-4 Laureth-2, PPG-4 Laureth-5, PPG-4 Laureth-7, PPG-4-Laureth-15, PPG-5-Laureth-5, PPG-6-Laureth-3, PPG-25-Laureth-25, PPG-14 Laureth-60 Hexyl Dicarbamate, PPG-4 Lauryl Ether, PPG-7 Lauryl Ether, PPG-2 Methyl Ether, PPG-3 Methyl Ether, PPG-4 Methyl Ether, PPG-2 Methyl Ether Acetate, PPG-10 Methyl Glucose Ether, PPG-20 Methyl Glucose Ether, PPG-25 Methyl Glucose Ether, PPG-20 Methyl Glucose Ether Acetate, PPG-20 Methyl Glucose Ether Distearate, PPG-3-Myreth-3, PPG-3-Myreth-11, PPG-3 Myristyl Ether, PPG-4 Myristyl Ether, PPG-3 Myristyl Ether Neoheptanoate, PPG-2 Myristyl Ether Propionate, PPG-4 Oleth-10 Dimethicone, PPG-10 Oleyl Ether, PPG-20 Oleyl Ether, PPG-23 Oleyl Ether, PPG-30 Oleyl Ether, PPG-37 Oleyl Ether, PPG-50 Oleyl Ether, PPG-14 Palmeth-60 Hexyl Dicarbamate, PPG/PEG-2/10 Glyceryl Cocoate, PPG-75-PEG-300 Hexylene Glycol, PPG-2-PEG-11 Hydrogenated Lauryl Alcohol Ether, PPG-1-PEG-9 Lauryl Glycol Ether, PPG-3-PEG-6 Oleyl Ether, PPG-65-PEG-5 Pentaerythrityl Ether, PPG-23-PEG-4 Trimethylolpropane, PPG-25-PEG-25 Trimethylolpropane, PPG-68-PEG-10 Trimethylolpropane, PPG-5 Pentaerythrityl Ether, PPG-8 Polyglyceryl-2 Ether, PPG-14 Polyglyceryl-2 Ether, PPG-70 Polyglyceryl-10 Ether, PPG-2 Propyl Ether, PPG-6-Sorbeth-245, PPG-6-Sorbeth-500, PPG-10 Sorbitol, PPG-25 Sorbitol, PPG-33 Sorbitol, PPG-41 Sorbitol, PPG-8 Sorbitol Castor Oil, PPG-9-Steareth-3, PPG-23-Steareth-34, PPG-30 Steareth-4, PPG-34-Steareth-3, PPG-38 Steareth-6, PPG-11 Stearyl Ether, PPG-15 Stearyl Ether, PPG-15 Stearyl Ether Benzoate, PPG-2 Tocophereth-5, PPG-5 Tocophereth-2, PPG-10 Tocophereth-30, PPG-20 Tocophereth-50, PPG-30 Tocophereth-70, PPG-70 Tocophereth-100, PPG-5 Tocopheryl Ether, PPG-1 Trideceth-6, PPG-4 Trideceth-6, PPG-6 Trideceth-8, PPG-77 Trimethylolpropane Ether, Propylene Glycol Butyl Ether, Propylene Glycol Capreth-4, Propylene Glycol lsodeceth-4, Propylene Glycol lsodeceth-12, Propylene Glycol Laureth-6, Propylene Glycol Oleth-5, Propylene Glycol Propyl Ether, Ricinoleth-40, Sodium C14-15 Pareth-PG Sulfonate, Sodium C12-14 Sec-Pareth-3 Sulfate, Sodium Laureth-2 Phosphate, Sodium Methoxy PPG-2 Acetate, Sodium PEG-50 Hydrogenated Castor Oil Succinate, Sodium Propoxy PPG-2 Acetate, Sorbeth-6, Sorbeth-20, Sorbeth-30, Sorbeth-40, Sorbeth-2 Cocoate, Sorbeth-40 Hexaoleate, Sorbeth-50 Hexaoleate, Sorbeth-3 Isostearate, Sorbeth-6 Laurate, Sorbeth-20 Pentaisostearate, Sorbeth-30 Pentaisostearate, Sorbeth-40 Pentaisostearate, Sorbeth-50 Pentaisostearate, Sorbeth-40 Pentaoleate, Sorbeth-20 Tetraisostearate, Sorbeth-30 Tetraisostearate, Sorbeth-40 Tetraisostearate, Sorbeth-50 Tetraisostearate, Sorbeth-4 Tetraoleate, Sorbeth-6 Tetraoleate, Sorbeth-30 Tetraoleate, Sorbeth-40 Tetraoleate, Sorbeth-60 Tetraoleate, Sorbeth-30 Tetraoleate Laurate, Sorbeth-60 Tetrastearate, Sorbeth-3 Tristearate, Soybean Oil PEG-36 Esters, Steareth-2, Steareth-3, Steareth-4, Steareth-5, Steareth-6, Steareth-7, Steareth-8, Steareth-10, Steareth-11, Steareth-13, Steareth-14, Steareth-15, Steareth-16, Steareth-20, Steareth-21, Steareth-25, Steareth-27, Steareth-30, Steareth-40, Steareth-50, Steareth-80, Steareth-100, Steareth-60 Cetyl Ether, Talloweth-4, Talloweth-5, Talloweth-6, Talloweth-7, Talloweth-18, TEA-Laureth-4 Phosphate, TEA-PEG-50 Hydrogenated Castor Oil Succinate, Tocophereth-5, Tocophereth-10, Tocophereth-12, Tocophereth-18, Tocophereth-50, Trideceth-2, Trideceth-3, Trideceth-4, Trideceth-5, Trideceth-6, Trideceth-7, Trideceth-8, Trideceth-9, Trideceth-10, Trideceth-11, Trideceth-12, Trideceth-15, Trideceth-18, Trideceth-20, Trideceth-21, Trideceth-50, Trideceth-9 PG-Amodimethicone, Trideceth-10 Phosphate, Triethanolamine Polyoxyethylene Alkylphenylethers Phosphate, Triglycereth-7 Citrate, Trilaureth-9 Citrate, Undeceth-3, Undeceth-5, Undeceth-7, Undeceth-8, Undeceth-9, Undeceth-11, and Undecyleneth-6.

The present invention further discloses a process for cleaning a surface, comprising the steps of: (a) providing a composition, wherein the composition comprises: at least one solvent, an alkaline agent, a deflocculant, at least one surfactant selected from the group comprising an alkoxylated alcohol surfactant, an alkylamino-polyethoxy-sulfate surfactant, a polyether-phosphate ester surfactant, a surfactant that is a phosphate ester of an ethoxylated alcohol, and a surfactant that is a polyethyleneglycol monoaklyl ether, and a bonding agent; and (b) associating the composition with the surface to be cleaned.

In another embodiment of the present invention, a composition comprises: one or more solvents, an alkaline agent, a deflocculant, one or more surfactants including, an alcohol ethoxylate surfactant, an alkylamino-polyethoxy-sulfate surfactant, a polyether-phosphate ester surfactant, a surfactant that is a phosphate ester of an ethoxylated alcohol, and a surfactant that is a polyethyleneglycol monoaklyl ether, and a bonding agent.

Preferably the one or more solvents comprises a polar solvent, such as water. However, it will be understood that any one of a number of other polar solvents that would be known to those having ordinary skill in the art are likewise contemplated for use.

The compositions of the present invention also comprise an alkaline agent, such as a hydroxide salt and/or a carbonate salt. Hydroxide salts include, for example, LiOH, NaOH (e.g. caustic soda), KOH, RbOH, CsOH, FrOH, Be(OH)₂, Mg(OH)₂, Ca(OH)₂, Sr(OH)₂, Ba(OH)₂, Ra(OH)₂, and mixtures thereof. Carbonate salts include, for example, group I and II carbonates. It will be understood that the alkaline agent serves to maintain alkalinity and/or enhance the properties of the anionic surfactants present in the composition. It further serves to neutralize napthenic acid and aid in its precipitation as insoluble salts. Applicant has uncovered that liquid caustic soda (typically 40-60% caustic) in combination with solid caustic soda appears to be a superior form of caustic soda.

A deflocculant is used, in accordance with the present invention, to aid in the treatment of the process water. The deflocculant serves as a de-emulsifier to facilitate the separation of water and oil from a water and oil emulsion. In a preferred embodiment, a combination of liquid sodium silicate and anhydrous sodium metasilicate (Drymet 59 available from the Crossfield Company) is utilized.

The compositions of the present invention also comprise one or more surfactants, including an alcohol ethoxylate surfactant, an alkylamino-polyethoxy-sulfate surfactant, a polyether-phosphate ester surfactant, a surfactant that is a phosphate ester of an ethoxylated alcohol, and a surfactant that is a polyethyleneglycol monoaklyl ether. An example of an alcohol-ethoxylate surfactant includes Triton XL-80N, which is commercially available from the Dow Chemical Company. An example of an alkylamino-polyethoxy sulfate surfactant includes Triton QS-15, which is commercially available from the Dow Chemical Company. An example of a polyether phosphate ester surfactant includes Triton QS-44, which is commercially available from the Dow Chemical Company.

Suitable surfactants that are phosphate esters of ethoxylated alcohols include, for example, Tyrfac 5553 and Tryfac 5554, which are commercially available from the Cognis Corporation. In accordance with the present invention, surfactants that are polyethyleneglycol monoaklyl ethers include, for example, Trycol 5968, Trycol 5949, and Trycol 5968, which are commercially available from the Henkel Corporation. It will be understood that while specific examples of surfactants have been disclosed for illustrative purposes only, any one of a number of other surfactants that would be known to those having ordinary skill in the art are likewise contemplated for use.

The compositions of the present invention also include a bonding agent, such as, for example, a low foam, non-polar, bonding. One preferred bonding agent is sodium xylene sulfonate, which is commercially available as Vanwet XSX-40 from the Univar Corporation.

Preferably, the percent by mass or percent by volume for each component identified in the compositions range from approximately 1 percent to approximately 50 percent, and more preferably range from approximately 1 percent to approximately 30 percent.

It will be understood that compositions may also include colored dyes, fragrances, etcetera. It will be appreciated by those skilled in the art that the compositions (i.e. mixtures of chemicals) employed in this invention can be prepared by any customary industry means.

In accordance with the present invention, the following non-limiting composition is provided:

### EXAMPLE I

1. Liquid caustic soda (40%-60% NaOH) (1 Gal.)

Caustic soda solid pellets (5Lbs.)
2. Liquid sodium silicate (13 Gal.)

Anhydrous sodium metasilicate (100 Lbs.)
3. Triton XL-80N (5 Gals.)

Triton QS-15 (2.5 Gals.)

Triton QS-44 (2.5 Gals.)
4. Trycol 5968 (10 Gals.)

Trycol 5949 (10 Gals.)
5. Vanwet SXS-40 (1 Gal.)
6. Acid Red 14 (color to suit)

The compositions employed in this invention result in the treatment of petroleum refinery process water to yield purified water that is free of contaminating napthenic acid, hydrocarbons, and solids when used in combination with the process elucidated in Example II.

### EXAMPLE II

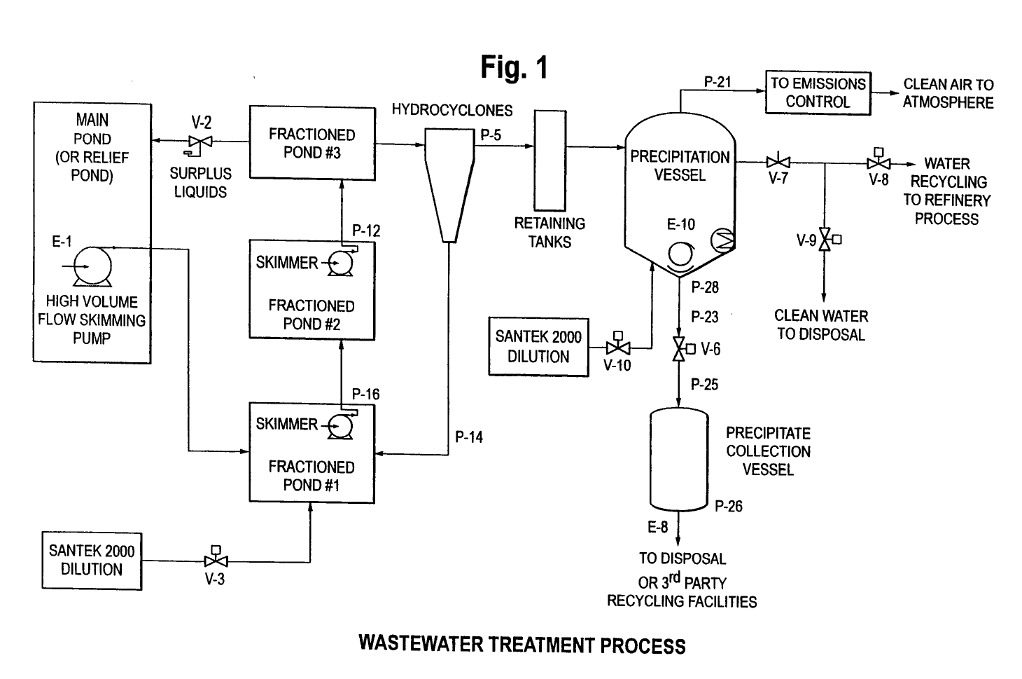

The present invention employs the mixture of chemicals in Example I with the following process. Referring now to FIG. 1, contaminated process water from a main pond is transferred into a first fractioned pond wherein the composition in Example I is provided (e.g. injected, infused, etcetera). Next, the first stage treated water from the first pond is transferred to a second fractioned pond. The second state treated water is then transferred to a third fractioned pond. It will be understood that when the water is going through these ponds it is getting retention time, starting the separation. The water is next sent to a hydrocyclone after being associated with the fractioned ponds. The hydrocyclone assists with dropping out any solids. After being exposed to the hydrocyclone, a majority of the water is transferred to the one or more retaining tanks. The remaining water and solids in the hydrocyclone can be sent back to the first fractioned pond. From the retaining tanks, the water is transferred to a precipitating vessel. In this vessel an auger will remove the salts at the bottom created from the napthenic acids. Once through the precipitating vessel, the bulk of the clean water is transferred back to the oil company for reuse. Water not to be reused is sent out as clean water for disposal.

The foregoing description merely explains and illustrates the invention and the invention is not limited thereto except insofar as the appended claims are so limited, as those skilled in the art who have the disclosure before them will be able to make modifications without departing from the scope of the invention.

What is claimed and desired to be secured by Letters Patent of the United States is:

1. A process for extracting crude oil, comprising the steps of:
providing an input source to an area of the earth having crude oil;
providing an output producer source to a recoverable area proximate the earth's surface;
introducing a composition through the input source to the area of the earth having the crude oil, wherein the composition comprises: at least one solvent, an alkaline agent, a deflocculant, at least one surfactant selected from the group comprising an alkoxylated alcohol surfactant, an alkylamino-polyethoxy-sulfate surfactant, a polyether-phosphate ester surfactant, a surfactant that is a phosphate ester of an ethoxylated alcohol, and a surfactant that is a polyethyleneglycol monoaklyl ether, and a bonding agent; and
extracting crude oil from the earth through the output producer source.

2. The process for extracting crude oil according to claim 1, wherein the step of introducing a composition through the input source to the area of the earth having the crude oil includes the step of introducing the composition which comprises water, caustic soda, a deflocculant, an alkoxylated alcohol surfactant, an alkylamino-polyethoxy-sulfate surfactant, a polyether-phosphate ester surfactant, a surfactant that is a phosphate ester of an ethoxylated alcohol, a surfactant that is a polyethyleneglycol monoaklyl ether, and a bonding agent.

3. The process for extracting crude oil according to claim 1, wherein the step of introducing a composition through the input source to the area of the earth having the crude oil includes the step of introducing the composition which comprises water, caustic soda, a deflocculant, Trycol 5941, an alkylamino-polyethoxy-sulfate surfactant, a polyether-phosphate ester surfactant, a surfactant that is a phosphate ester of an ethoxylated alcohol, a surfactant that is a polyethyleneglycol monoaklyl ether, and a bonding agent.

4. A process for extracting crude oil using steam-assisted gravity drainage, comprising the steps of:
providing an input line to an area of the earth having crude oil;
providing an output producer line to a recoverable area proximate the earth's surface;
introducing steam through the input line;
introducing a composition through the input line to the area of the earth having the crude oil, wherein the composition comprises: at least one solvent, an alkaline agent, a deflocculant, at least one surfactant selected from the group comprising an alkoxylated alcohol surfactant, an alkylamino-polyethoxy-sulfate surfactant, a polyether-phosphate ester surfactant, a surfactant that is a phosphate ester of an ethoxylated alcohol, and a surfactant that is a polyethyleneglycol monoaklyl ether, and a bonding agent; and
extracting crude oil from the earth through the output producer line.

5. The process for extracting crude oil using steam-assisted gravity drainage according to claim 4, wherein the step of introducing a composition through the input source to the area of the earth having the crude oil includes the step of introducing the composition which comprises water, caustic soda, a deflocculant, an alkoxylated alcohol surfactant, an alkylamino-polyethoxy-sulfate surfactant, a polyether-phosphate ester surfactant, a surfactant that is a phosphate ester of an ethoxylated alcohol, a surfactant that is a polyethyleneglycol monoaklyl ether, and a bonding agent.

6. The process for extracting crude oil using steam-assisted gravity drainage according to claim 4, wherein the step of introducing a composition through the input source to the area of the earth having the crude oil includes the step of introducing the composition which comprises water, caustic soda, a deflocculant, Trycol 5941, an alkylamino-polyethoxy-sulfate surfactant, a polyether-phosphate ester surfactant, a surfactant that is a phosphate ester of an ethoxylated alcohol, a surfactant that is a polyethyleneglycol monoaklyl ether, and a bonding agent.

7. A process for purifying extracted oil, byproducts, and wastewater, comprising the steps of:
providing a composition, wherein the composition comprises: at least one solvent, an alkaline agent, a deflocculant, at least one surfactant selected from the group comprising an alkoxylated alcohol surfactant, an alkylamino-polyethoxy-sulfate surfactant, a polyether-phosphate ester surfactant, a surfactant that is a phosphate ester of an ethoxylated alcohol, and a surfactant that is a polyethyleneglycol monoaklyl ether, and a bonding agent; and
associating the composition with at least one of extracted oil, byproducts, and wastewater.

8. The process for purifying extracted oil, byproducts, and wastewater according to claim 7, wherein the step of providing the composition includes the step of providing the composition which comprises water, caustic soda, a deflocculant, an alkoxylated alcohol surfactant, an alkylamino-polyethoxy-sulfate surfactant, a polyether-phosphate ester surfactant, a surfactant that is a phosphate ester of an ethoxylated alcohol, a surfactant that is a polyethyleneglycol monoaklyl ether, and a bonding agent.

9. The process for purifying extracted oil, byproducts, and wastewater according to claim 8, wherein the step of associating the composition with at least one of extracted oil, byproducts, and wastewater includes the step of associating the composition with at least one of froth, middlings, tailings, mature fine tailings, solids, and combinations thereof.

10. The process for purifying extracted oil, byproducts, and wastewater according to claim 9, wherein the step of associating the composition with at least one of extracted oil, byproducts, and wastewater includes the step of associating the composition with froth.

11. The process for purifying extracted oil, byproducts, and wastewater according to claim 9, wherein the step of associating the composition with at least one of extracted oil, byproducts, and wastewater includes the step of associating the composition with middlings.

12. The process for purifying extracted oil, byproducts, and wastewater according to claim 9, wherein the step of associating the composition with at least one of extracted oil, byproducts, and wastewater includes the step of associating the composition with tailings.

13. The process for purifying extracted oil, byproducts, and wastewater according to claim 9, wherein the step of associating the composition with at least one of extracted oil, byproducts, and wastewater includes the step of associating the composition with mature fine tailings.

14. The process for purifying extracted oil, byproducts, and wastewater according to claim 9, wherein the step of associating the composition with at least one of extracted oil, byproducts, and wastewater includes the step of associating the composition with solids.

15. A process for cleaning a surface, comprising the steps of:
providing a composition, wherein the composition comprises: at least one solvent, an alkaline agent, a deflocculant, at least one surfactant selected from the group comprising an alkoxylated alcohol surfactant, an alkylamino-polyethoxy-sulfate surfactant, a polyether-phosphate ester surfactant, a surfactant that is a phosphate ester of an ethoxylated alcohol, and a surfactant that is a polyethyleneglycol monoaklyl ether, and a bonding agent; and
associating the composition with the surface to be cleaned.

16. The process for cleaning a surface according to claim 15, wherein the step of providing a composition includes the step of providing the composition which comprises water, caustic soda, a deflocculant, an alkoxylated alcohol surfactant, an alkylamino-polyethoxy-sulfate surfactant, a polyether-phosphate ester surfactant, a surfactant that is a phosphate ester of an ethoxylated alcohol, a surfactant that is a polyethyleneglycol monoaklyl ether, and a bonding agent.

17. The process for cleaning a surface according to claim 15, wherein the step of providing a composition includes the step of providing the composition which comprises water, caustic soda, a deflocculant, Trycol 5941, an alkylamino-polyethoxy-sulfate surfactant, a polyether-phosphate ester surfactant, a surfactant that is a phosphate ester of an ethoxylated alcohol, a surfactant that is a polyethyleneglycol monoaklyl ether, and a bonding agent.
